(19) United States
(12) Patent Application Publication
(10) Pub. No.: US 2005/0284957 A1
(43) Pub. Date: Dec. 29, 2005

(54) External mix air atomizing spray nozzle assembly

(75) Inventor: James Haruch, Naperville, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Spraying Systems Co., Wheaton, IL (US)

(21) Appl. No.: 11/212,902

(22) Filed: Aug. 26, 2005

Related U.S. Application Data
(63) Continuation-in-part of application No. 10/252,194, filed on Sep. 23, 2002.

(51) Int. Cl. B05B 1/28

(52) U.S. Cl. 239/290; 239/291; 239/292; 239/294; 239/8

(57) ABSTRACT

An external mix air atomizing spray nozzle assembly comprising a nozzle body having liquid and air flow passages, and an air cap formed with an air chamber communicating with said air passage and a plurality of angled pressurized air discharge passages communicating with said chamber at an angle to a central axis of said spray nozzle assembly for directing pressurized air onto a liquid flow stream discharging from said liquid passage. The angled air discharge passages each are defined by a conical indentation in a front face of the air cap and a cylindrical bore communicating in perpendicular relation to a side surface of the conical indentation. The design of the angled air discharge passages permits easy manufacture and design modification for particular spray applications.

### RELATED APPLICATION

The present application is a continuation-in-part of application Ser. No. 10/252,194, filed Sep. 23, 2002, the disclosure of which is incorporated hereby by reference.

### FIELD OF THE INVENTION

The present invention relates generally to spray nozzle assemblies, and more particularly, to “external mix” air atomizing spray nozzle assemblies in which a discharging liquid flow stream is atomized and formed into the desired spray pattern by pressurized air externally of the liquid discharge orifice.

### BACKGROUND OF THE INVENTION

External mix air atomizing spray nozzles are known for their ability to control of liquid particle size and spray distribution by pressurized air, independent of the liquid flow rate. They also can be used with relatively low pressure air supplies, such as on the order of 15 psi, which can be generated from inexpensive blowers, rather than air compressors. However, such spray nozzles typically must be formed with intricate air flow passages which communicate through the spray nozzle to locations downstream of the liquid discharge orifice. Such passageways are expensive to manufacture, create pressure losses, and if not formed with precision and accuracy can result in burrs and passage misalignments that cause further pressure losses that detract from efficient operation of the spray nozzle. Hence, the pressurized air supply generated by low-pressure blowers sometimes is inadequate to enable effective liquid particle breakdown and direction. Moreover, while external mix air atomizing spray nozzles have been used for producing flat fan spray patterns, heretofore they have not been effective, at low pressures, for generating full cone liquid spray patterns with substantially uniform liquid particle breakdown.

External air atomizing spray nozzles also can experience performance problems, particularly when spraying viscous liquids, slurries, or other solids containing liquids. Such viscous liquids and/or solids tend to build up on the discharge end of the spray nozzle as an incident to mixing with the pressurized atomizing air. Such build up is particularly prone to external mix air atomizing spray nozzles which have downstream extending ears from which the pressurized air streams discharge.

### OBJECTS AND SUMMARY OF THE INVENTION

It is an object of the present invention to provide an external mix air atomizing spray nozzle assembly which is adapted for more efficient and reliable operation, even when spraying highly viscous liquids, slurries, and other solids containing liquids.

Another object is to provide an external mix air atomizing spray nozzle assembly as characterized above which is less susceptible to clogging and solids build up on external surfaces from liquids being sprayed.

A further object is to provide an external mix air atomizing spray nozzle assembly of the above kind which eliminates the necessity for protruding pressurized air directing ears, and hence, the potential of clogging solids build-up upon air discharge orifices of such ears.

Still another object is to provide such an external mix air atomizing spray nozzle assembly of the foregoing type which can be effectively operated at relatively low air pressures in producing flat or full cone liquid spray patterns with substantially uniform liquid particle breakdown.

Yet a further object is to provide such an external mix air atomizing spray nozzle in which the air cap can be easily designed and manufactured for particular spray applications and is interchangeable on a standard nozzle body.

Other objects and advantages of the invention will become apparent upon reading the following detailed description and upon reference to the drawings, in which:

### BRIEF DESCRIPTION OF THE DRAWING(S)

FIG. 1 is a longitudinal section of an illustrative spray nozzle assembly in accordance with the invention;

FIG. 2 is an end view of the air cap of the illustrated spray nozzle assembly taken in the plane of line 2-2 in FIG. 1;

FIGS. 3A-3C are diagrammatic depictions illustrating a method of manufacturing the illustrated air cap in accordance with the invention;

FIG. 4 is a longitudinal section of an alternative embodiment of air cap in accordance with the invention; and

FIGS. 5-7 are end views of alternative embodiments of air caps in accordance with the invention;

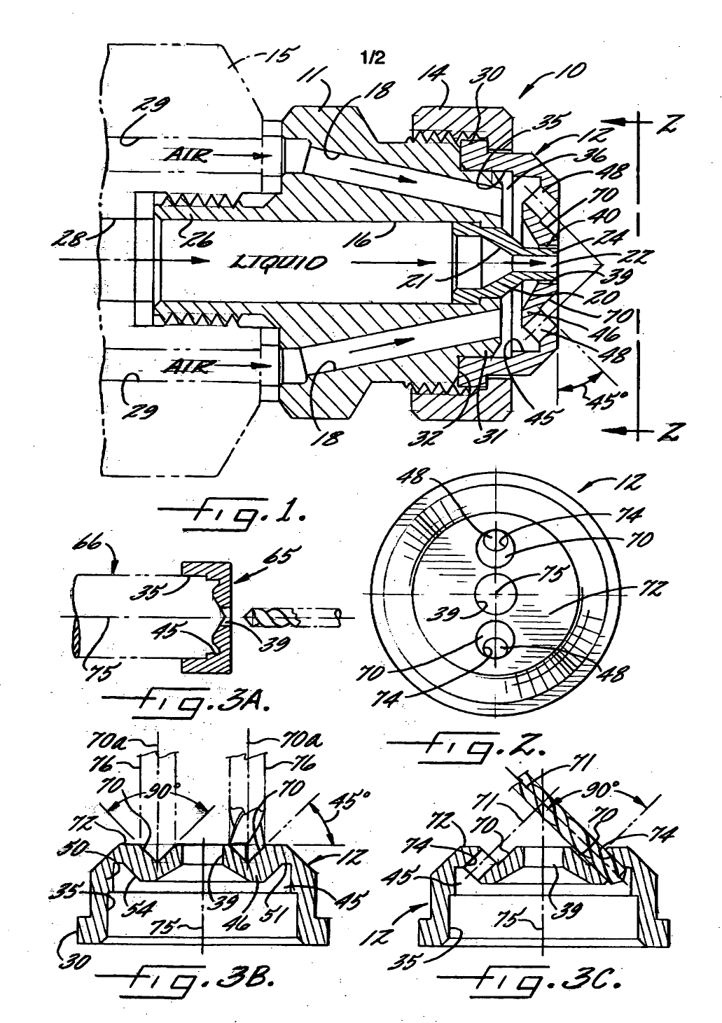

While the invention is susceptible of various modifications and alternative constructions, certain illustrated embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention.

### DETAILED DESCRIPTION OF THE INVENTION

Referring now more particularly to the drawings, there is shown an illustrative spray nozzle assembly 10 embodying the present invention. The spray nozzle assembly 10 in this case comprises a nozzle body 11, an air cap 12 mounted at the downstream into the nozzle body 11, and a retaining ring 14 for releasably securing the air cap 12 in mounted position. The illustrated spray nozzle assembly 10 is mounted on a base or manifold portion 15 through which pressurized liquid and air is supplied from appropriate sources.

The illustrated nozzle body 11 is formed with a central liquid passage 16 and a plurality of pressurized air or gas passages 18 disposed in circumferentially spaced relation about the liquid passage 16. The liquid passage 16 in this case communicates with a liquid discharge spray tip 20 fixed in the downstream end of the nozzle body 11 in forwardly extending relation thereto. The liquid spray tip 20 defines a tapered entry chamber 21 which communicates with a smaller diameter liquid discharge passage 22 formed in a relatively small diameter nose 24 of the spray tip 20. The air passages 18 extend in substantially straight fashion between upstream and downstream ends of the nozzle body 11 in inwardly tapered relation to the longitude axis of the nozzle assembly.

The nozzle body 11 is connected to the base portion 15 by a rearwardly extending externally threaded stem 26 of the nozzle body 11 received in a threaded cavity in the base portion 15 with the liquid and air passages 16, 18 of the nozzle body 11 communicating with the liquid and air passages 28, 29 in the base portion 15. Liquid and air inlet ports (not shown) communicate respectively with the liquid and air passages 28, 29 provided in the manifold portion 15. In a known manner, suitable supply lines can be attached to the liquid and gas inlet ports to supply the nozzle assembly 10 with pressurized liquid and gas.

The air cap 12 has a cylindrical upstream end portion with an outwardly extending radial flange 30 that is secured to the nozzle body 11 by the retaining ring 14 which is threaded into an externally threaded portion of the nozzle body 11. For ensuring proper seating of the air cap 12 on the nozzle body 11, a downstream end of the nozzle body 11 is formed with a cylindrical hub 31 onto which the air cap 12 is positionable against an annular seat 32 of the nozzle body 11.

In accordance with the invention, the air cap has a simple to manufacture construction which enables more efficient utilization of pressurized air in atomizing and directing the desired liquid spray pattern. The illustrated air cap 12 in this case is formed with an upstream opening counterbore or chamber 35 that is mountable on the nozzle body hub 31 and which together with the end of the nozzle body 11 defines a generally cylindrical air chamber 36 communicating with the nozzle body air passages 18. The air cap 12 is further formed with a central cylindrical opening 39 which receives the forwardly extending nose 24 of the liquid spray tip 20. The downstream end of the spray tip nose 24 is located adjacent the downstream end of the cylindrical opening 39 and is concentrically disposed within the opening 39 such that the outer perimeter of the nose 24 and the cylindrical opening 39 define an annular air passage 40 communicating with the cylindrical air chamber 36. It will be seen that pressurized air communicated from the air inlet passage 29 through the nozzle body air passage 18 and into the cylindrical air chamber 36 of the air cap 12 will communicate through the annular air passage 40 and discharge in surrounding relation to a liquid flow stream discharging from the spray tip 20, preliminarily atomizing and axially directing the discharging liquid flow stream.

In carrying out the invention, the air cap 12 is formed with an annular air plenum or chamber 45 which defines a central hub 46. The annular air plenum or chamber 45 in this case is defined by an outer cylindrical sidewall 50 which is only slightly smaller in diameter than the counterbore 35, a downstream end wall 51 perpendicular thereto, and an outwardly tapered sidewall 54. The central hub 46 defined by the annular plenum 45 is formed with a plurality of angled air discharge passages 48 communicating with the annular plenum or chamber 45 for directing angled pressurized air streams against the discharging liquid for further atomizing and forming the discharging liquid spray into the desired spray pattern.

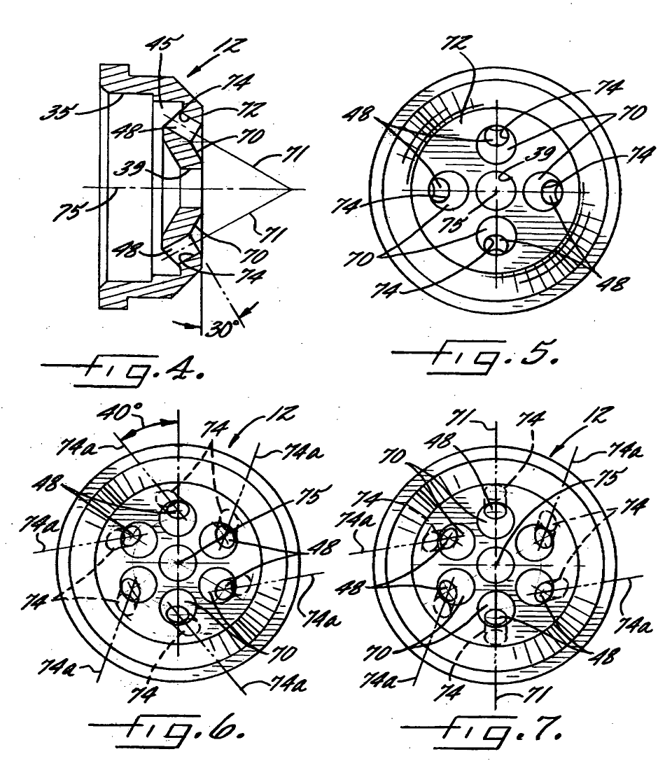

In keeping with the invention, the air cap 12 lends itself to economical manufacture and may be machined without tight tolerances. From a cylindrical blank 65, as depicted in FIG. 3A, the cylindrical chamber 35 and annular air plenum 45 may be machined in a forming operation. It will be understood that the cylindrical air chamber 35 and annular air plenum 45 may be formed with a single forming tool 66 in a single machining operation, or alternatively, may be formed in a multiple-step machining operation with separate forming tools. The central axial passage 39 also may be readily drilled or formed (as shown by phantom lines).

In accordance with an important aspect of the invention, the air cap air discharge passages 48 are adapted for relatively precise, yet economical, customized design and manufacture for particular spray applications. To this end, each angled air cap air discharge passage 48 is defined by a respective conical indentation or dimple 70 having an axis 70a perpendicular to an end face 72 of the air cap 12 and a straight cylindrical bore 74 communicating perpendicularly through a side surface of the conical indentation 70 to the annular plenum 45. As depicted in FIG. 3B, the conical indentations 70 have axes 70a parallel to a central longitudinal axis 75 of the air cap 12 and may be formed by the drill point of a standard drill oriented parallel to the air cap axis 75. In the illustrated embodiment, a drill bit 76 (FIG. 3B) having a 90° tip results in tapered sides of the conical indentation 70 being disposed at a 45° angle to a plane normal to the longitudinal air cap axis 75.

In further carrying out the invention, the cylindrical bores 74 may be formed in a standard drilling operation directed perpendicularly to a side surface of the indentation 70. As will be understood by persons skilled in the art, a drilling operation forming such cylindrical bore 74 may be effectively and reliably carried out since the drill point is oriented perpendicularly by the drilling surface, and hence, is less likely to move or walk at the beginning of the drilling operation as in the case when drilling at an acute angle to a surface. Since the bores are drilled between a side surface of the conical indentation 70 and the annular plenum 45 there also is no need for precise aligned connection between angled bores, typical of the prior art. In the illustrated embodiment, as depicted in FIG. 3C, the axes 71, 74 of the cylindrical bores 74 are in the plane of the central axis 75 of the air cap 12. Hence, with the cylindrical bores 74 formed in perpendicular relation to a tapered side of the conical indentation 70, the bores 74 are oriented at an angle of 45° to the longitudinal air cap axis 75 for directing pressurized air streams 48 at such 45° angle to the discharging liquid flow stream. It can further be seen that the discharge ends of angled air discharge orifices 48 are recessed from the front face 72 of the air cap 12 so as to be less susceptible to solids build-up and clogging than conventional air caps having protruding air discharge ears.

In further keeping with the invention, the design of the air cap 12 of the present invention can be readily modified for the desired spray pattern and liquid particle distribution dependent upon the angle of the conical indentations, while in each case permitting the manufacture of the bore 74 by drilling or the like in perpendicular relation to a side surface of the conical indentation. At the outset, it will be appreciated that the angle of the conical indentations 70 may be varied simply by selection of the standard drill bit tip angle. As shown in FIG. 4, a drill bit with a 120° drill point will result in indentations with sides at an angle of 30° to a plane normal to the longitudinal air cap axis 75, such that cylindrical bore 74 drilled in perpendicular relation to a side surface of that indentation 70 results in the air discharge passage 48 being oriented at 30° to the air cap axis. Pressurized air streams emitted from such smaller angled air discharge passages will impinge the discharging liquid flow stream in closer proximity to the end face of the air cap, resulting in a wider spray pattern.

In accordance with a further aspect of the invention, the number of cylindrical bores 74 and their orientation relative to the discharging liquid flow stream can be easily varied for the particular spray characteristics, while utilizing a common shaped axially oriented conical indentation 70. As shown in FIG. 2, forming the air cap 12 with a pair of opposed angled air discharge orifices 48 is effective for generating a relatively flat spray pattern. Providing a plurality of circumferentially spaced air discharge orifices, as depicted in FIG. 5, permits generation of a round full cone spray pattern.

In keeping with still a further feature of the invention, an air cap may be provided that is effective for generating a full cone spray pattern for even highly viscous materials. To this end, in the embodiment shown in FIG. 6, the cylindrical bores 74, while formed in perpendicular relation to a side surface of the conical indentation 70, have axes 74a that are in skewed or tangentially offset relation to the central air cap axis 75 (i.e., not in a common plane of the central air cap axis) so as to create a swirling action of the discharging liquid and enhanced atomization of the full cone spray pattern. In the embodiment shown in FIG. 7, some of the cylindrical bores 74 have axes that are not in the plane of the central axis of the air cap (i.e., the pairs of cylindrical bores on left and right hand sides of the air cap as viewed in FIG. 7), while other of the cylindrical bores 74 are in the plane of the air cap axis 75 (i.e., the bores on opposed top and bottom sides of the air cap as viewed in FIG. 7) for generating an elongated discharging spray with liquid particles throughout the spray pattern.

From the foregoing, it can be seen that the external mix air atomizing spray nozzle assembly of the present invention is adapted for efficient and reliable operation, even when spraying highly viscous liquids, slurries, and other solids containing liquids. The air cap of the nozzle assembly has angled air discharge orifices that are recessed from the end face of the air cap, and hence, less susceptible to the potential for clogging from solids build-up. The air cap further can be easily designed and manufactured for particular spray applications and is interchangeable on standard nozzle bodies.

1. An air assisted spray nozzle assembly comprising:
a nozzle body having a liquid passage for connection to a pressurized liquid supply and an air passage for connection to a pressurized air supply,
said liquid passage having a downstream liquid discharge orifice from which a pressurized liquid stream is axially discharged,
an air cap disposed adjacent said nozzle body formed with an air chamber communicating with said air passage and a plurality of angled pressurized air discharge passages communicating with said chamber at an angle to an axis of said liquid discharge orifice for directing pressurized air onto a liquid flow stream discharging from said liquid discharge orifice at a location downstream of the liquid discharge orifice for further atomizing the liquid and directing discharging liquid into a predetermined spray pattern, and
said angled air discharge passages each being defined at least in part by a conical indentation in a front face of the air cap and a cylindrical bore communicating in perpendicular relation to a side surface of the conical indentation.

2. The spray nozzle assembly of claim 1 in which said conical indentations of said air cap each have an axis parallel to a the axis of the liquid discharge orifice.

3. The spray nozzle assembly of claim 1 in which said cylindrical bores of said air cap each have an axis in the plane of liquid discharge orifice.

4. The spray nozzle assembly of claim 1 in which said cylindrical bores of said air cap each have an axis oriented that is tangentially offset and not in a common plane of the axis of said liquid discharge orifice for creating a swirling action in the discharging liquid spray.

5. The spray nozzle assembly of claim 1 in which the cylindrical bores have at least some of said angled air discharge passages have axes in the plane of said liquid discharge orifice axis and the cylindrical bores of other of said angled air discharge passages have axes that are tangentially offset and not in a common plane of said liquid discharge orifice axis.

6. The air assisted spray nozzle assembly of claim 1 in which said air cap chamber includes an annular plenum, and said cylindrical bores each extend straight, without bend, between said annular plenum and a respective one of said conical indentations.

7. The spray nozzle assembly of claim 1 in which said liquid passage discharge orifice is defined by a liquid spray tip fixed in said nozzle body, said air cap having a central opening coaxial with said liquid discharge orifice and said liquid spray tip having a nose concentrically located in said central air cap opening for defining an annular air discharge passage communicating with said air chamber through which pressurized air is axially directed in surrounding relation to a liquid flow stream discharging from said liquid discharge orifice.

8. An air cap for an external mix air atomizing spray nozzle comprising an air cap body having a central axial opening, said body being formed with an air supply chamber in an upstream side thereof and a plurality of angled pressurized air discharge passages communicating with said chamber at an angle to the axis of said air cap opening effective for directing angled pressurized air streams downstream of said central opening, and said angle discharge passages each being defined at least in part by a conical indentation in a front face of the air cap body and a cylindrical bore communicating in perpendicular relation with a side surface of the conical indentation.

9. The air cap of claim 8 in which said conical indentations each have an axis parallel to the axis of said central opening.

10. The air cap of claim 8 in which said cylindrical bores each have an axis in the plane of the axis of said central opening.

11. The air cap of claim 8 in which at least some of said bores have an axis oriented in skewed relation and not in the common plane of the axis of said central opening.

12. The air cap of claim 8 in which said air supply chamber includes an annular plenum, and said cylindrical bores each extend straight without bend, between said annular plenum and a respective one of said conical indentations.

13. A method of making an air cap for an air assisted spray nozzle assembly comprising the steps of:
providing a cylindrical blank, forming an air chamber in an upstream end of said blank, forming a plurality of conical indentations in a downstream end of said blank with axes of said indentations being parallel to a central axis of said cylindrical blank, and forming angled air flow passages in said blank by drilling a cylindrical bore through and in perpendicular relation to a tapered side of each said conical indentation.

14. The method of claim 13 including forming said conical indentations by drilling with a conical point drill.

15. The method of claim 13 including forming said air chamber with an annular plenum, and forming each said cylindrical bore in communication with said annular plenum.

16. The method of claim 13 including forming a central coaxial opening in said blank communicating with said air chamber.
